(19) United States
(12) Patent Application Publication
(10) Pub. No.: US 2010/0057568 A1
(43) Pub. Date: Mar. 4, 2010

(54) Method and Apparatus for Searching for Online Advertisement Resource

(75) Inventors: Zhao Dai, Shenzhen (CN); Yueping Jiang, Shenzhen (CN)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Tencent Technology (Shenzhen) Company Ltd., Shenzhen (CN)

(21) Appl. No.: 12/616,130

(22) Filed: Nov. 10, 2009

Related U.S. Application Data
(63) Continuation of application No. PCT/CN08/71931, filed on Aug. 7, 2008.

(30) Foreign Application Priority Data
Aug. 11, 2007 (CN) CN 200710075688.X

(51) Int. Cl. G06Q 30/00

(52) U.S. Cl. 705/14.54

(57) ABSTRACT

Embodiments of the present invention provide a method and apparatus for searching for an online advertisement resource. The method includes: setting at least one label for each of online advertisement resources; categorizing the at least one label according to a categorizing rule; categorizing a keyword inputted by a user when searching for an online advertisement resource according to the categorizing rule; and if a category to which the keyword belongs has a label, transmitting the online advertisement resource corresponding to the label to the user. The embodiments of the present invention increase success rate and accuracy for finding the online advertisement resource, and lower the requirement for searching conditions. Compared with the prior art, the problem that it is difficult to find a matching result and that a potential online advertisement resource may be missed is solved.

### FIELD OF THE INVENTION

The present invention relates to network communication techniques, and more particularly, to a method and apparatus for searching for an online advertisement resource.

### BACKGROUND OF THE INVENTION

An online advertisement, also referred to as network advertisement or Internet advertisement, is a kind of advertisements published through the Internet. The online advertisement includes an advertisement on websites, instant messaging tools, webcasting software and downloading software. The online advertisement has many types such as text linkage advertisement, flag advertisement and video advertisement, etc. An online advertisement resource refers to an advertisement location for exhibiting an advertisement, e.g. a location for exhibiting an advertisement on a website or instant messaging software. A network media publishing the online advertisement generally has numerous and complicated online advertisement resources. For example, qq.com has more than 3,000 online advertisement resources and there are more than 100 types of advertisements. These online advertisement resources usually have different attributes, e.g. different target audience characteristics, geography distributions and advertising performances.

In the prior art, when searching for an online advertisement resource, a category and name matching manner is adopted, i.e., the online advertisement resources are categorized and named firstly, then a search may be performed according to category names or names of the online advertisement resources. As shown in FIG. 1, when searching for an online advertisement resource, a user inputs a keyword. A required online advertisement resource is found by matching the keyword with the category names of the online advertisement resources to find a category name or with the names of the online advertisement resources to find a name. For example, the online advertisement resources may be divided into several categories, including a webpage advertisement, an in-game advertisement, etc. For the webpage advertisement, a homepage full banner is taken as the name of the online advertisement resource. When searching for an online advertisement resource, the required online advertisement resource can be found only if the inputted keyword is the webpage advertisement or the homepage full banner.

In view of the above, in the search process of the prior art, there are few search conditions. The required online advertisement resource can be found only when the keyword inputted by the user completely matches the category name or the name of the online advertisement resource, which requires much for the search condition. Therefore, it is hard to find a matching online advertisement resource and it is very possible to miss a potential online advertisement resource.

### SUMMARY OF THE INVENTION

Embodiments of the present invention provide a method and apparatus for searching for an online advertisement resource, which increase success ratio for searching for the online advertisement resource.

According to one aspect of the present invention, a method for searching for an online advertisement resource is provided. The method includes:

setting at least one label for each of online advertisement resources;

categorizing the at least one label according to a categorizing rule;

categorizing a keyword inputted by a user when searching for an online advertisement resource according to the categorizing rule; and

if a category to which the keyword belongs has a label, transmitting the online advertisement resource corresponding to the label to the user.

According to another aspect of the present invention, an apparatus for searching for an online advertisement resource is provided. The apparatus includes:

a first initializing module, adapted to net at least one label for each of online advertisement resources;

a categorizing module, adapted to categorize the at least one label set by the first initializing module according to a categorizing rule, and categorize a keyword inputted by a user when searching for an online advertisement resource according to the categorizing rule; and

a matching and transmitting module, adapted to transmit, if a category to which the keyword inputted by the user belongs has a label, the online advertisement resource corresponding to the label to the user.

In the embodiments of the present invention, through generating categories and setting labels for the online advertisement resources, and through putting the labels and the keyword used by the user into the categories according to the same categorizing rule, the embodiments of the present invention may transmit the online advertisement resource corresponding to the label in the same category as the keyword to the user, which increases the success ratio and accuracy for searching for the online advertisement resource. After labels are set for the online advertisement resources, the non-structural information is added with structural attributes. Users, such as advertisement sales men, may search for an online advertisement resource according to target audience characteristics, geography distribution and advertising performances or other information of the online advertisement resource, which lowers the requirement for the searching condition. The labels and the keyword are categorized according to the same categorizing rule, which greatly increases the accuracy and effectiveness of the searching result and thus is favorable for the sales men to select appropriate advertisement resources for customers.

Compared with the prior art, the keyword is not necessary to be the same as the name or category name of the online advertisement resource. As long as the keyword and the label are put into the same category, the online advertisement resource can be found. As such, the problem that it is difficult to find a matching result is solved. Accordingly, the problem that a potential online advertisement resource may be missed is also avoided.

### BRIEF DESCRIPTION OF THE DRAWINGS

FIG. 1 is a schematic diagram illustrating a search of an online advertisement resource in the prior art.

FIG. 2 is shows a structure of an apparatus for searching for an online advertisement resource according to an embodiment of the present invention.

FIG. 3 shows a structure of a categorizing module according to an embodiment of the present invention.

FIG. 4 shows a structure of a categorizing module according to an embodiment of the present invention.

FIG. 5 is a flowchart illustrating a method for searching for an online advertisement resource according to an embodiment of the present invention.

FIG. 6 is a flowchart illustrating a method for searching for an online advertisement resource according to an embodiment of the present invention.

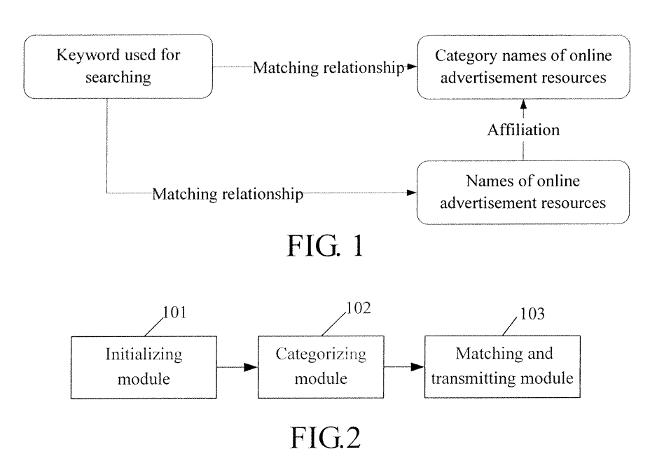

### DETAILED DESCRIPTION OF THE INVENTION

The present invention will be described in detail hereinafter with reference to accompanying drawings and embodiments to make the technical solution and merits therein clearer.

In an embodiment of the present invention, through setting labels for the online advertisement resources, the labels and a keyword used by the user for searching may be categorized according to a same categorizing rule. Thus, the online advertisement resource corresponding to a label which is in a same category as the keyword used by the user may be transmitted to the user. As such, the accuracy of searching for the online advertisement resource may be increased. Before setting the labels for the online advertisement resources or before categorizing the labels and the keyword according to the same categorizing rule, the embodiment of the present invention further includes: generating categories. The categorizing the labels and the keyword according to the same categorizing rule includes: respectively putting the labels and the keyword into the generated categories. In an embodiment of the present invention, it is also possible to utilize categories already existing on a network. At this time, the categorizing the labels and the keyword according to the same categorizing rule includes: respectively putting the labels and the keyword into the categories already existing on the network.

FIG. 2 shows a structure of an apparatus for searching for an online advertisement resource according to an embodiment of the present invention. As shown in FIG. 2, the apparatus includes: an initializing module 101, a categorizing module 102 and a matching and transmitting module 103.

The initializing module 101 is adapted to set labels for online advertisement resources.

The process of setting the labels includes: attaching at least one word or phrase for each online advertisement resource as a label for the online advertisement resource according to attribute information of the online advertisement resource. The attribute information includes: type, target audience characteristic, geography distribution and advertising performance of the online advertisement resource. For example, for an online advertisement resource of cars, multiple labels, e.g. “DongFeng Citroën”, “white”, “saving-fuel”, etc., may be set.

The categorizing module 102 is adapted to categorize the labels set by the initializing module 101, categorize a keyword inputted by a user when searching for an online advertisement resource, and send a categorizing result to the matching and transmitting module 103.

The keyword inputted by the user may be a category name, target audience characteristic, geography distribution information and advertising performance of the required online advertisement resource.

The categorizing module 102 adopts a sat e categorizing rule to categorize the labels and the keyword.

The matching and transmitting module 103 is adapted to transmit, if a category into which the keyword inputted by the user is put by the categorizing module 102 has a label, an online advertisement resource corresponding to the label to the user.

The initializing module 101 is further adapted to generate categories. The initializing module 101 may generate the categories according to various rules. The categories generated may have a tree structure, i.e. generate a category tree. For example, the categories may be generated according to industries, or according to product types, or according to the types of the online advertisement resources, and then a category tree forms. Preferably, the categorizing module 102 respectively puts the labels and the keyword into the categories generated by the initializing module 101.

In one embodiment of the present invention, categories existing on the network may also be used. As such, the initializing module 101 is not necessary to have the function of generating the categories. The categorizing module 102 respectively puts the labels and the keyword into the categories existing on the network.

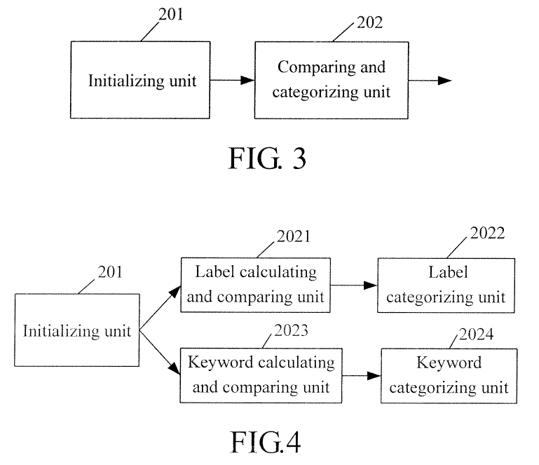

FIG. 3 shows a structure of a categorizing module according to an embodiment of the present invention. As shown in FIG. 3, the categorizing module 102 includes: an initializing unit 201 and a comparing and categorizing unit 202.

The initializing unit 201 is adapted to select a fixed number of training materials for each category generated by the initializing module 101 and send the training materials to the comparing and categorizing unit 202.

The training materials may be articles relevant to the category. The number of the training materials may be selected according to practical requirements. For example, it is possible to select 20 articles as the training materials for each category in the category tree.

The comparing and categorizing unit 202 is adapted to calculate frequency that a label set by the initializing module 101 emerges in the training materials selected by the initializing unit 201 for each category, select highest frequency and put the label configured by the initializing module 101 into the category corresponding to the highest frequency; calculate frequency that the keyword used for searching emerges in the training materials selected by the initializing unit 201 for each category, select highest frequency and put the keyword into the category corresponding to the highest frequency.

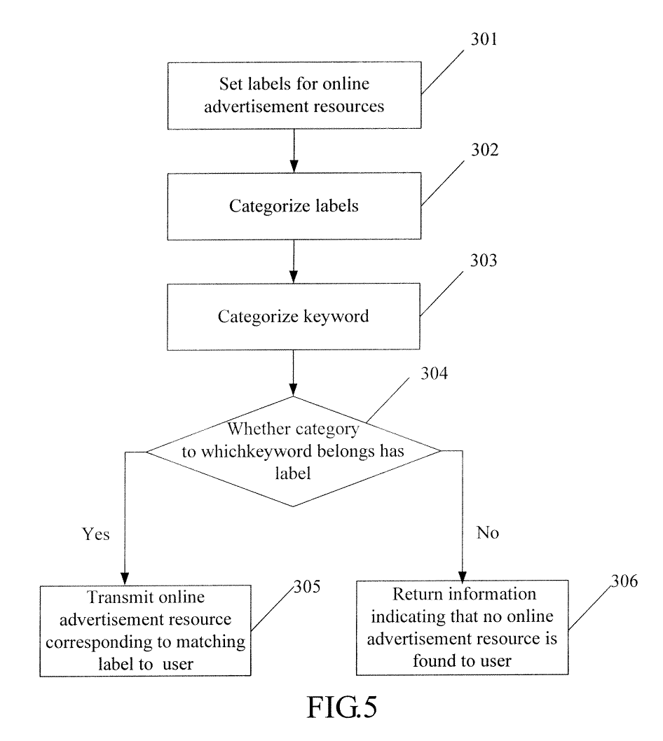

FIG. 4 shows a structure of a categorizing module according to an embodiment of the present invention. As shown in FIG. 4, the comparing and categorizing unit 202 includes: a label calculating and comparing unit 2021, a label categorizing unit 2022, a keyword calculating and comparing unit 2023 and a keyword categorizing unit 2024.

The label calculating and comparing unit 2021 is adapted to calculate frequency that the label set by the initializing module 101 emerges in the training materials selected by the initializing unit 201 for each category, and compare the frequency for different categories to obtain highest frequency.

The label categorizing unit 2022 is adapted to put the label set by the initializing module 101 into the category corresponding to the highest frequency obtained by the label calculating and comparing unit 2021.

The keyword calculating and comparing unit 2023 is adapted to calculate frequency that the keyword inputted by the user when searching for an online advertisement resource emerges in the training materials selected by the initializing unit 201 for each category, and compare the frequency for different categories to obtain highest frequency.

The keyword categorizing unit 2024 is adapted to put the keyword inputted by the user when searching for the online advertisement resource into the category corresponding to the highest frequency obtained by the keyword calculating and comparing unit 2023.

In this embodiment, the functions of the label calculating and comparing unit 2021 and the functions of the keyword calculating and comparing unit 2023 may be implemented in one unit (e.g. a calculating and comparing unit). The functions of the label categorizing unit 2022 and the functions of the keyword categorizing unit 2024 may be implemented in one unit (e.g. a categorizing unit).

FIG. 5 is a flowchart illustrating a method for searching for an online advertisement resource according to an embodiment of the present invention. As shown in FIG. 5, the method includes the following steps.

Step 301: Set at least one label for each online advertisement resource.

Step 302: Categorize the at least one label according to a categorizing rule.

Step 303: Categorize a keyword. When the keyword inputted by a user for searching for an online advertisement resource is received, the keyword is categorized according to the same categorizing rule as the at least one label.

Step 304: Determine whether a category which the keyword belongs to has a label; if the category has a label, take the label as a matching label and proceed to Step 305; otherwise, proceed to Step 306.

Step 305: Transmit an online advertisement resource corresponding to the matching label to the user.

Step 306: Return information indicating that no online advertisement resource is found to the user.

Before Step 301 or Step 302, the method may further include a step of generating categories. At this time, the step of categorizing the at least one label in Step 302 may be: putting the at least one label into the categories generated. And the step of categorizing the keyword in Step 303 may be putting the keyword into a category generated.

In an embodiment of the present invention, it is also possible to use categories already existing on the network. Thus, Step 302 and Step 303 may be as follows: respectively putting the at least one labels and the keyword into the categories existing on the network.

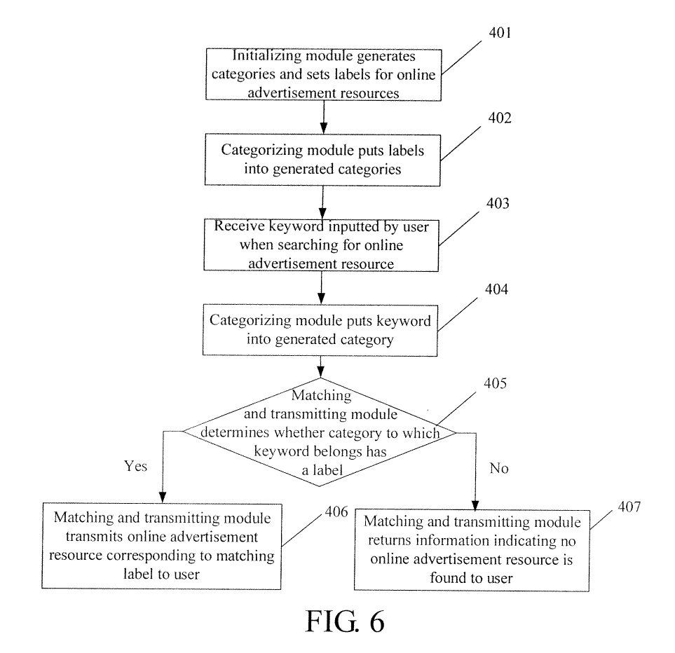

In an embodiment of the present invention, the method for searching for an online advertisement resource may be implemented by the apparatus provided by the embodiments of the present invention. As shown in FIG. 6, embodiments of the present invention provide a method for searching for an online advertisement resource, wherein an initializing module generates categories. The method includes the following steps.

Step 401: The initializing module generates categories and sets at least one label for each online advertisement resource.

A manner of categorizing words in a tree structure, i.e. generating a category tree, may be adopted to generate the categories. The initializing module may categorize words of natural languages according to a pre-defined rule. The pre-defined rule may be: categorizing the words according to industries and generating the category tree, or categorizing the words according to product types and generating the category tree, or categorizing the words according to types of online advertisement resources and generating the category tree, etc. The generated categories have a tree structure, i.e. a large category includes several small categories and each small category is further divided into smaller categories, and so forth. As such, the categories are in a multi-layer structure.

For example, as shown in Table 1, there are two large categories: “beauty” and “health”, which are categorized according to industries. The category “beauty” is further divided into 7 small categories: perfume, hairdressing, skin care, making-up, hair removal, cosmetics and figure management. The category “health” is further divided into 9 small categories: disease and symptom, Chinese traditional medicine, nursing and physical examination, pregnant and bearing, hospital, treatment instrument, healthy food, health management and baby fostering. The categories are in two layers, i.e. the category tree as shown in Table 1.

TABLE 1

| | |
|---|---|
| Beauty | Perfume |
| | Hairdressing |
| | Skin care |
| | making-up |
| | Hair removal |
| | Cosmetics |
| | Figure management |
| Health | Disease and symptom |
| | Chinese traditional medicine |
| | Nursing and physical examination |
| | Pregnancy and bearing |
| | Hospital |
| | Treatment instrument |
| | Healthy food |
| | Health management |
| | Baby fostering |

The online advertisement resources are non-structural information and not easy to be searched. The initializing module sets labels for the online advertisement resources and thus changes them into structural information. The labels may be information relevant to the online advertisement resources. According to attribute information of an online advertisement resource, at least one word or phrase may be taken as label(s) for the online advertisement resource, i.e. associate the online advertisement resource with the attached word or phrase. The attribute information of the online advertisement resource includes: type, target audience characteristic, geography distribution and advertising performance of the online advertisement resource. The label may have a name identical with the category name of the online advertisement resource or a different name.

For example, the online advertisement resource is a sports channel homepage full banner and information relevant to the online advertisement resource includes: 1) type information, such as sports requisites, athletics, body building, etc.; 2) target audience characteristic information, such as gender, hobbies, age distribution, etc.; 3) geography distribution information, such as south, north, Shenzhen, Beijing, etc.; 4) advertising performance information, such as clicking rate, converting rate, etc. According to the above information, one or more labels, e.g. sports requisites, sports suit, drink, male, Beijing, etc., may be set for the sports channel homepage full banner.

For another example, the online advertisement resource is a baby channel homepage full banner headline and its relevant information includes: 1) type information, such as pregnancy care, baby care, baby education, etc.; 2) target audience characteristic information, such as gender, hobbies, age distribution, etc.; 3) geography distribution information, such as south, north, Shenzhen, Beijing, etc.; 4) advertising performance information, such as clicking rate, converting rate, etc. According to the above information, one or more labels, e.g. pregnancy, health, baby, milk power, etc., may be set for the baby channel homepage full banner headline.

Step 402: The categorizing module puts the at least one label set by the initializing module for each online advertisement resource into categories generated by the initializing module.

There are many manners to put the at least one label into the categories, such as a statistical analysis manner. The details are as follows:

The categorizing module selects a fixed number of training materials for each category generated by the initializing module, calculates frequency that a label set by the initializing module for an online advertisement resource emerges in the training materials of each category, compares the frequency for different categories to obtain highest frequency, puts the label set by the initializing module for the online advertisement resource into a category corresponding to the highest frequency.

For example, the online advertisement resource “baby channel homepage full banner headline” has a label “milk powder”. The generated category tree is shown as Table 1. The two large categories have 16 small categories. And for each category, 20 training materials (such as articles relevant to the category) are selected. Then frequency that the label “milk powder” emerges in the training materials of each category is calculated. For example, the frequency in the 20 training materials of the category “pregnancy and bearing” is 80%, and the frequency in the 20 training materials of the category “baby fostering” is 50%, etc. The calculated frequency for different categories is compared to obtain highest frequency. In this embodiment, it is supposed that the highest frequency is 80%. Then the label “milk powder” is put into the category “pregnancy and bearing” which corresponds to the highest frequency 80%.

When calculating the frequency that the label of the online advertisement resource emerges in the training materials of each category, Term Frequency (TF) and Inverse Document Frequency (IDF) may be used. For example, the frequency may be calculated according to the following formula:

Frequency=TF*IDF;

wherein TF indicates frequency of a term emerging in a large number of training materials. The higher the frequency is, the higher the value of TF is. IDF indicates a weight that ate in should be cut off from a large number of training materials. The more important the term is, the lower the value of IDF is. The result of TF*IDF is the frequency that the label emerges in the training materials.

Step 403: Receive a keyword inputted by the user when searching or an online advertisement resource.

The keyword may be information relevant to the online advertisement resource, e.g., category name, target audience characteristic information, geography distribution information and advertising performance information, etc.

Step 404: The categorizing module puts the keyword into a category generated by the initializing module.

The method for putting the keyword into the category is the same as that for putting the at least one label into the categories in Step 402. In particular, a statistical analysis manner may be adopted. The details are as follows:

The categorizing module selects a fixed number of training materials for each category generated by the initializing module, calculates frequency that the keyword emerges in the training materials of each category, compares the frequency for different categories to obtain highest frequency, puts the keyword into a category corresponding to the highest frequency.

It is supposed that the keyword inputted by the user is “radiation-proof clothing”. After the processing of the categorizing module, it is found that the frequency that the keyword “radiation-proof clothing” emerges in the 20 training materials of the category “pregnancy and bearing” is also the highest frequency, e.g. 70%. Thus, the keyword “radiation-proof clothing” is put into the category “pregnancy and bearing” which corresponds to the highest frequency 70%.

Step 405: After determining that the categorizing module has put the keyword into the corresponding category, the matching and transmitting module determines whether the category which the keyword belongs to has a label; if yes, proceed to Step 406; otherwise, proceed to Step 407.

The process of the matching and transmitting module determining whether the category to which the keyword belongs has a label is actually a matching process. If the keyword and the label belong to the same category, the matching succeeds. There may be one or more matching labels.

Step 406: The matching and transmitting module transmits the online advertisement resource corresponding to the matching label to the user, and terminates the procedure.

In this embodiment, the category “pregnancy and bearing” to which the keyword belongs has a label “milk powder”. Thus, the matching succeeds and there is one matching label. The online advertisement resource (e.g. the baby channel homepage full banner headline) corresponding to the label “milk powder” is transmitted to the user.

If there are multiple matching labels, all online advertisement resources corresponding to the labels may be transmitted to the user in the form of list data to be reviewed by the user.

Step 407: The matching and transmitting module does not find an appropriate online advertisement resource, and returns information indicating that no online advertisement resource is found to the user. Then, the procedure is terminated.

According to embodiments of the present invention, the generated categories may be other cases, but not limited to the categories shown in Table 1. As to other cases, a successful matching example may be as follows:

A label “university entrance examination” is set for a full banner of a university entrance examination column on an education channel of a website. The label “university entrance examination” is put into the category “education” of the category tree. A user inputs a keyword “university” for searching for an online advertisement resource. The keyword “university” is also put into the category “education” of the category tree. Thus, the matching succeeds. The full banner of the university entrance examination column on the education channel corresponding to the label “university entrance examination” is returned to the user as a searching result.

In the embodiments of the present invention, through generating categories and setting labels for the online advertisement resources, and through putting the labels and the keyword used by the user into the categories according to the same categorizing rule, the embodiments of the present invention can transmit the online advertisement resource corresponding to the label in the same category as the keyword to the user, which increases the success ratio and accuracy for searching for the online advertisement resource. As labels are set for the online advertisement resources, the non-structural information is added with structural attributes. Users, such as advertisement sales men, may search for an online advertisement resource according to target audience characteristic, geography distribution and advertising performance or other information of the online advertisement resource, which lowers the requirements for the searching condition. The labels and the keyword are categorized according to the same categorizing rule, which greatly increases the accuracy and effectiveness of the searching result and thus is favorable for the sales men to select appropriate advertisement resources for customers. Compared with the prior art, the keyword is not necessary to be the same as the name or category name of the online advertisement resource. As long as the keyword and the label belong to the same category, the online advertisement resource can be found. As such, the problem that it is difficult to find a matching result is solved. Accordingly, the problem that a potential online advertisement resource may be missed is also avoided.

The foregoing descriptions are only preferred embodiments of this invention and are not for use in limiting the protection scope thereof. Any changes and modifications can be made by those skilled in the art without departing from the spirit of this invention and therefore should be covered within the protection scope as set by the appended claims.

1. A method for searching for an online advertisement resource, comprising:
setting at least one label for each of online advertisement resources;
categorizing the at least one label according to a categorizing rule;
categorizing a keyword inputted by a user when searching for an online advertisement resource according to the categorizing rule; and
if a category to which the keyword belongs has a label, transmitting the online advertisement resource corresponding to the label to the user.

2. The method of claim 1, further comprising:
generating categories;
the categorizing the at least one label according to the categorizing rule comprises:
putting the at least one label into the categories according to the categorizing rule;
the categorizing the keyword inputted by the user when searching for the online advertisement resource according to the categorizing rule comprises:
putting the keyword into a category according to the categorizing rule.

3. The method of claim 1, wherein the categorizing the at least one label according to the categorizing rule comprises: putting the at least one label into categories existing on a network according to the categorizing rule; and
the categorizing the keyword inputted by the user when searching for the online advertisement resource according to the categorizing rule comprises: putting the keyword into a category existing on the network according to the categorizing rule.

4. The method of claim 2, wherein the putting the at least one label into the categories comprises:
selecting a fixed number of training materials for each category;
calculating frequency that a label emerges in the training materials of each category, selecting highest frequency; and
putting the label into a category corresponding to the highest frequency.

5. The method of claim 3, wherein the putting the at least one label into the categories comprises:
selecting a fixed number of training materials for each category;
calculating frequency that a label emerges in the training materials of each category, selecting highest frequency; and
putting the label into a category corresponding to the highest frequency.

6. The method of claim 2, wherein the putting the keyword into the category comprises:
selecting a fixed number of training materials for each category;
calculating frequency that the keyword emerges in the training materials of each category, selecting highest frequency; and
putting the keyword into the category corresponding to the highest frequency.

7. The method of claim 3, wherein the putting the keyword into the category comprises:
selecting a fixed number of training materials for each category;
calculating frequency that the keyword emerges in the training materials of each category, selecting highest frequency; and
putting the keyword into the category corresponding to the highest frequency.

8. The method of claim 1, wherein the keyword comprises: category name, target audience characteristic information, geography distribution information and advertising performance information of the online advertisement resource to be searched.

9. An apparatus for searching for an online advertisement resource, comprising:
a first initializing module, adapted to set at least one label for each of online advertisement resources;
a categorizing module, adapted to categorize the at least one label set by the first initializing module according to a categorizing rule, and categorize a keyword inputted by a user when searching for an online advertisement resource according to the categorizing rule; and
a matching and transmitting module, adapted to transmit, if a category to which the keyword inputted by the user belongs has a label, the online advertisement resource corresponding to the label to the user.

10. The apparatus of claim 9, wherein the first initializing module is further adapted to generate categories; and
the categorizing module is further adapted to put the at least one label set by the first initializing module into the categories generated by the first initializing module, and put the keyword into a category generated by the first initializing module.

11. The apparatus of claim 9, wherein the categorizing module is further adapted to put the at least one label set by the first initializing module into categories existing on a network, and put the keyword into a category existing on the network.

12. The apparatus of claim 8, wherein the categorizing module further comprises:
a second initializing unit, adapted to select a fixed number of training materials for each category generated by the first initializing module or each category existing on the network; and
a comparing and categorizing unit, adapted to calculate frequency that a label set by the first initializing module emerges in the training materials selected by the second initializing unit for each category, select first highest frequency, and put the label into the category corresponding to the first highest frequency; calculate frequency that the keyword emerges in the training materials selected by the second initializing unit for each category, select second highest frequency and put the keyword into the category corresponding to the second highest frequency.

13. The apparatus of claim 9, wherein the categorizing module further comprises:
a second initializing unit, adapted to select a fixed number of training materials for each category generated by the first initializing module or each category existing on the network; and
a comparing and categorizing unit, adapted to calculate frequency that a label set by the first initializing module emerges in the training materials selected by the second initializing unit for each category, select first highest frequency, and put the label into the category corresponding to the first highest frequency; calculate frequency that the keyword emerges in the training materials selected by the second initializing unit for each category, select second highest frequency and put the keyword into the category corresponding to the second highest frequency.

14. The apparatus of claim 12, wherein the comparing and categorizing module comprises:
a label calculating and comparing unit, adapted to calculate the frequency that the label set by the first initializing module emerges in the training materials selected by the second initializing unit for each category, compare frequency for different categories and select the first highest frequency;
a label categorizing unit, adapted to put the label into the category corresponding to the first highest frequency selected by the label calculating and comparing unit;
a keyword calculating and comparing unit, adapted to calculate the frequency that the keyword inputted by the user when searching for the online advertisement resource emerges in the training materials selected by the second initializing unit for each category, compare frequency for different categories and select the second highest frequency; and
a keyword categorizing unit, adapted to put the keyword inputted by the user when searching for the online advertisement resource into the category corresponding to the second highest frequency selected by the keyword calculating and comparing unit.

15. The apparatus of claim 12, wherein the comparing and categorizing unit comprises:
a calculating and comparing unit, adapted to calculate the frequency that the label set by the first initializing module emerges in the training materials selected by the second initializing unit for each category, compare frequency for different categories and select the first highest frequency; and calculate the frequency that the keyword inputted by the user when searching for the online advertisement resource emerges in the training materials selected by the second initializing unit for each category, compare frequency for different categories and select the second highest frequency; and
a categorizing unit, adapted to put the label set by the first initializing module into the category corresponding to the first highest frequency selected by the calculating and comparing unit, and put the keyword into the category corresponding to the second highest frequency selected by the calculating and comparing unit.
